(19) United States
(12) Patent Application Publication
(10) Pub. No.: US 2005/0076715 A1
(43) Pub. Date: Apr. 14, 2005

(54) Shear sensor apparatus

(76) Inventors: Matthew M. Kuklis, Harrison, OH (US); Charles A. Lachenbruch, Summerville, SC (US); Jerrold J. Beeney, North Andover, MA (US)

Correspondence Address: BARNES & THORNBURG, 11 SOUTH MERIDIAN, INDIANAPOLIS, IN, 46204, US

(21) Appl. No.: 10/684,241

(22) Filed: Oct. 13, 2003

(51) Int. Cl. G01P 15/02

(52) U.S. Cl. 73/541

(57) ABSTRACT

A shear sensor apparatus may be used to sense shear forces between a first body and a second body. Illustratively, the first body may be a patient and the second body may be a hospital bed. The shear sensor apparatus may comprise a first piece and a second piece that moves along a shear plane. A sensor may be interposed between the first and second pieces. The sensor may comprise a strain gage. The sensor may comprise a flexible material to which the strain gage is mounted.

### BACKGROUND OF THE INVENTION

The present disclosure relates to sensors, and particularly to shear sensors. The shear sensors of the present disclosure may be used, for example, to sense forces exerted on a patient by movable sections of a patient-support device. The shear sensors of the present disclosure may be used in other applications as well and are not intended to be limited to the illustrative uses shown and described herein.

Devices exist for sensing shear forces. There are, for example, the devices shown and described in U.S. Pat. Nos. 6,188,331; 5,747,698; 5,571,973; 5,490,427; 5,230,252; 5,209,126; 5,174,159; 4,944,181; and RE37,065 E. This list of prior art patents is exemplary and not exhaustive.

### SUMMARY OF THE INVENTION

An apparatus for sensing shear between a first body, such as a patient, and a second body, such as a portion of a patient-support device, that moves relative to the first body is provided and has one or more of the following features or combinations thereof, which alone or in any combination may comprise patentable subject matter. The apparatus may have a first piece that is stationary relative to the first body and a second piece that moves with the second body. A sensor may be interposed between the first and second pieces. The sensor may comprise a strain gage. The sensor may comprise a third piece of flexible material to which the strain gage is mounted. The third piece may comprise an elastomeric block of material. The third piece may comprise a flexible plate. The first piece may comprise a first plate. The second piece may comprise a second plate. The second piece may slide on the first piece. The second piece may be spaced from the first piece. One of the first and second pieces may have a recess in which the sensor is situated. One of the first and second pieces may have a stop that interacts with the third piece of material. The stop may comprise one or more posts. The stop may comprise a surface which bounds a recess.

Additional features, which alone or in combination with any other feature(s), such as those listed above, may comprise patentable subject matter and will become apparent to those skilled in the art upon consideration of the following detailed description of various embodiments exemplifying the best mode of carrying out the shear sensor apparatus as presently perceived.

### BRIEF DESCRIPTION OF THE DRAWINGS

The detailed description particularly refers to the accompanying figures, in which:

FIG. 1 is a perspective view of a patient support-device having a first embodiment of a shear sensor apparatus positioned thereon;

FIG. 2 is a perspective view of the shear sensor apparatus of FIG. 1;

FIG. 3 is an exploded perspective view of the shear sensor apparatus of FIG. 2, showing a first piece, a second piece, and a sensor coupled to the second piece;

FIG. 4 is a sectional view, taken along line 4-4 of FIG. 2, showing a portion of the sensor engaging a stop formed in the first piece;

FIG. 5 is a perspective view of a second embodiment of a shear sensor apparatus;

FIG. 6 is an exploded perspective view of the shear sensor apparatus of FIG. 5 showing a first piece having a pair of screw-receiving apertures, a sensor situated above the first piece, a second piece having a recess sized to receive the sensor, a pair of screws aligned with the apertures of the first piece, and a pair of washers between the first piece and the sensor;

FIG. 7 is a sectional view, taken along line 7-7 of FIG. 5, showing the sensor coupled to the first piece and extending in a cantilevered manner within the recess of the second piece;

FIG. 8 is an exploded perspective view of a third embodiment of a shear sensor apparatus showing a first piece, a first pair of posts extending from the first piece, a second piece, a second pair of posts extending from the second piece, a sensor above the first piece, and the sensor having holes which receive the first and second pairs of posts; and

FIG. 9 is a sectional view, similar to FIG. 7, of the shear sensor apparatus of FIG. 8 showing the sensor sandwiched between the first and second pieces and the posts each mating with a respective hole in the sensor.

### DETAILED DESCRIPTION OF THE DRAWINGS

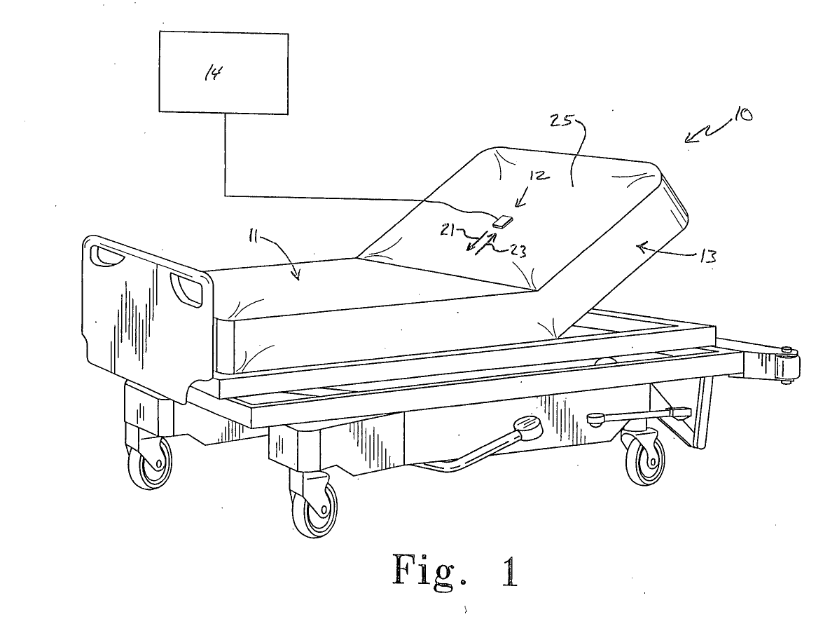

An apparatus 12 for sensing shear is placed between a patient (not shown) and a patient-support device 10, such as a hospital bed, operating room table, stretcher, chair, and the like, as shown, for example, in FIG. 1. Illustratively, apparatus 12 is placed upon a head section 13 of patient-support device 10. As head section 13 pivots or otherwise moves between raised and lowered positions, the patient's torso may have a tendency to shift or move in a first direction 21 or a second direction 23. In the illustrative example, directions 21, 23 are generally parallel with an upper surface 25 of head section 13 and are oriented along the longitudinal dimension (i.e. the head-to-foot dimension) of head section 13.

In the illustrative example, apparatus 12 produces a signal which indicates shear between the patient and head section 13 of device 10. The signal is communicated to processing equipment 14, such as a P3500 Strain Indicator available from Measurements Group, Inc. of Raleigh, N.C. Equipment 14 is illustrated diagrammatically in FIG. 1 to indicate broadly that all types of equipment, including but not limited to computers, displays, printers, signal conditioning circuitry, signal conversion circuitry (such as analog-to-digital conversion circuitry), power circuitry, transmitters, receivers, transceivers, alarm circuitry and the like, may be included in the equipment 14 that receives and/or processes the signal communicated from apparatus 12. Equipment 14 may, in turn, communicate with other equipment (not shown), such as equipment included in a computer network or the Internet, for example. Communication between equipment 14 and any other equipment may be via a wired connection or wirelessly and may be in accordance with any type of communication protocol.

Relative movement between the patient and head section 13 in either of directions 21, 23 produces shear forces on the patient and on the mattress. These shear forces may lead to complications such as skin breakdown or decubitus ulcers. In addition, these shear forces may exacerbate patient discomfort if, for example, the patient has a wound on a body part in contact with surface 25 of head section 13. Thus, manufacturers of patient-support devices sometimes attempt to design these devices to minimize shear forces upon patients. Apparatus 12 and equipment 14 may be used to compare one design of a patient-support device to another.

In the illustrative example of FIG. 1, one apparatus 12 is placed between a mattress 11 of device 10 and a patient supported on mattress 11. If desired, multiple shear sensor apparatus 12 maybe placed: between device 10 and the patient at various locations on mattress 11. Alternatively, one or more apparatus 12 may be placed between mattress 11 and portions of device 10 that support mattress 11. For example, one or more apparatus 12 may be placed between the portion of mattress 11 associated with head section 13 and an underlying frame or panel that comprises a part of the deck (not shown) that supports mattress 11. Furthermore, apparatus 12 may be integrated into mattress 11 or another portion of device 10. One or more apparatus 12 may be integrated into a mannequin, anthropometric dummy, or any other object that is used to test shear on patient support devices by placement thereon.

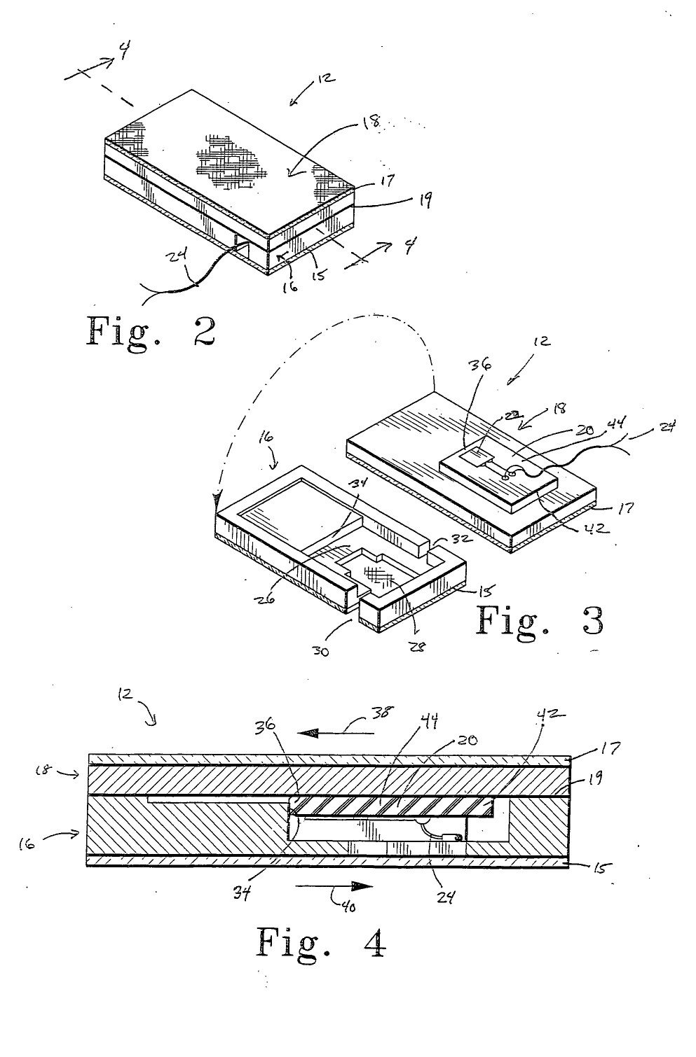

Apparatus 12 comprises a first piece 16 and a second piece 18 that is separable from first piece 16 as shown in FIG. 3. Illustratively, first and second pieces 16, 18 are substantially rectangular in shape, and can move relative to each other along a shear plane 19 when mated together as shown in FIGS. 2 and 4. First and second pieces 16, 18 are also illustratively not interlocking and can be easily pulled apart. However, it should be understood that, in alternative embodiments, first and second pieces 16, 18 may interlock or join to each other via suitable mechanisms, such as tongue-and-groove structures, track and roller assemblies, linear bearings, or the like, that permit movement of pieces 16, 18 by some amount along shear plane 19 but that prevent pieces 16, 18 from easily separating. If desired, first and second pieces 16, 18 may have anti-friction material or mechanisms employed therebetween, such as lubricants, rollers, balls, or the like. However, in the illustrative embodiment, pieces 16, 18 simply slide relative to one another without such anti-friction material or mechanisms. The thickness of apparatus 12 is illustratively approximately 0.25 inch, although other thicknesses are within the scope of the disclosure.

A sensor 20 is interposed between the first and second pieces 16, 18 and, in the illustrative example, is coupled to second piece 18. Sensor 20 may comprise, for example, a material that is deformable when subjected to pressure and that has a characteristic which changes in response to deformation. For example, in some embodiments, sensor 20 comprises one or more strain gages 22, such as a CEA-XX-125UW-350 (where XX is a numerical place-holder that specifies the type of material application), available from Measurements Group, Inc. of Raleigh, N.C., that changes resistance characteristics when deformed. Other examples of suitable sensing devices that my be used in sensor 20 in lieu of strain gage 22 include, but are not limited to, piezoelectric devices, capacitive devices, and inductive devices. Leads 24 extend from sensor 20 and are in electrical communication with processor 14.

In the illustrative example, when pieces 16, 18 move along shear plane 19, gage 22 deforms and changes impedance, which results in a change in the amount of electrical current flowing in leads 24. The change of current in leads 24 provides the signal that is received and processed by equipment 14. Illustratively, sensor 20 is formed in a substantially rectangular shape, and is configured to fit into a cavity 26 formed in first piece 16. Sensor 20 comprises a resilient material, such as an elastomeric material or a metal.

Cavity 26 is formed to be slightly larger in dimension than sensor 20, and cavity 26 has a lower recess 28, which accommodates structure, such as solder beads and electrical conductors used to couple electrical leads 24 to gage 22 of sensor 20 without the direct contact of such structure with first piece 16. Notches 30, 32 may also be formed in first piece 16 to provide a passageway for leads 24. It should be understood that first piece 16, second piece 18, and sensor 20 can each be made from single pieces of material, although, in the illustrative embodiment, first piece 16, second piece 18, and sensor 20 each comprise multiple pieces of material. Illustratively, first piece 16 comprises a metal block and a high friction outer layer 15 (such as rubber or any other polyurethane material) coupled thereto, and second piece 18 also comprises a metal block and a high friction outer layer 17 coupled thereto.

Layers 15, 17 may be made from rubber or a Neoprene® material, for example. Layers 15, 17 may be made from a similar material or a dissimilar material. Such high friction outer layers 15, 17 enhance the ability of apparatus 12 to grip the surfaces or bodies that apparatus 12 is positioned between, such as the surface 25 of device 10 and the back of the patient. Alternatively, one or both of layers 15, 17 may be made from a low friction material, or any desired type of material for that matter. For example, some mattresses used in hospital beds have outer coverlets made of Penn Nyla® material. Therefore, layer 17, which is in contact with the patient in the illustrative example, may be made from Penn Nyla® material so that the friction which exists between the patient and the underlying mattress when apparatus 12 is situated therebetween, is approximately the same as the friction which exists between the patient and the mattress without apparatus 12 being situated therebetween.

As can be seen in FIGS. 3-4, a stop 34 is formed in first piece 16, the stop 34 being configured to interact with a first portion 36 of sensor 20. Illustratively, when second piece 18 moves in a direction 38 relative to first piece 16, or first piece 16 moves in the direction 40 relative to second piece 18, or both, as can be seen in FIG. 4, the shear forces creating this movement cause sensor 20 to deform as it is pushed against stop 34 of first piece 16. Such deformation is sensed by gage 22, and output signals are transmitted via leads 24 to processor 14. Illustratively, gage 22 is mounted in close proximity to first portion 36. If desired, gage may be mounted anywhere between first portion 36 and a second portion 42 of sensor 20. Illustratively, portions 36, 42 comprises the opposite ends of sensor 20. Illustratively, leads 24 are coupled to gage 22 near a third central portion 44 of sensor 20.

In the illustrative example, directions 38, 40 that first and second pieces 16, 18 may move are parallel with directions 21, 23, respectively, that the patient may move relative to surface 25 as head section 13 is moved between raised and lowered positions. Thus, shear plane 19 is generally parallel with surface 25 of head section 13 of mattress 11. Also in the illustrative example, the first and second bodies (i.e., the patient and head section 13 of device 10) are in contact with each other in the regions of surface 25 adjacent to, but outboard of, apparatus 12 and, in fact, the surface area of contact between the patient and surface 25 far exceeds the surface area of contact between the patient and apparatus 12 (and the surface area of contact between apparatus 12 and surface 25). Thus, the presence of apparatus 12 between the patient and surface 25 of head section 13 has very little affect, if any, on the sliding characteristics between the patient and head section 13. In other uses of one or more of apparatus 12, the first and second bodies may not be in contact at all or may have a surface area of contact that is substantially equal to or less than the surface area of contact between the one or more apparatus 12 and the first and second bodies.

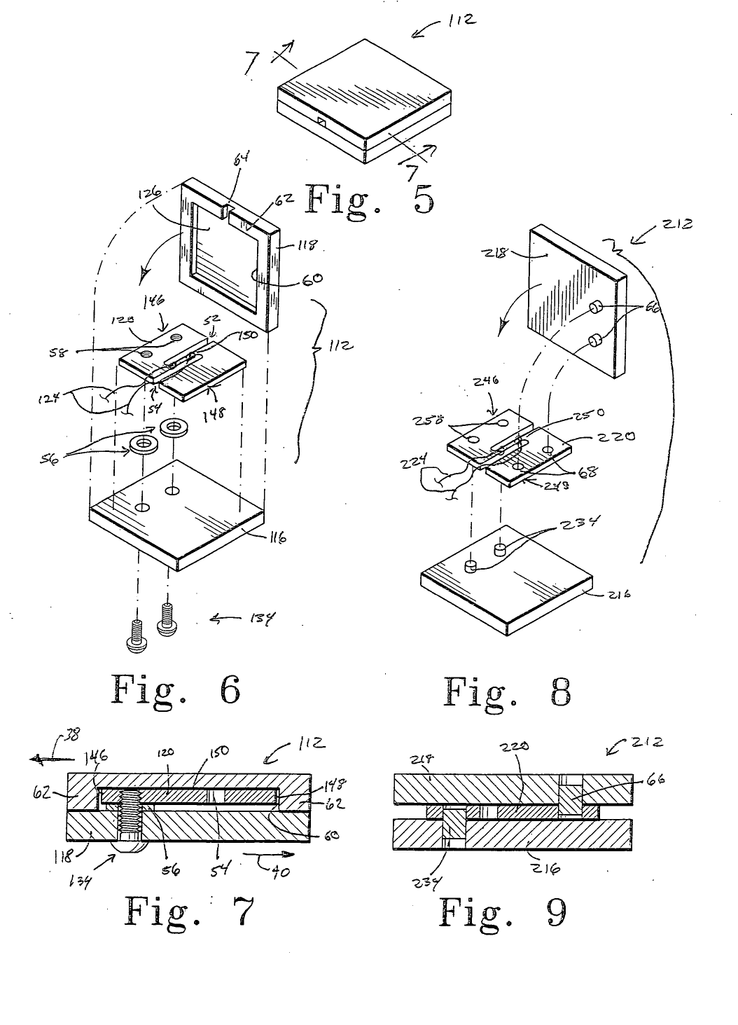

Another embodiment of a shear sensor apparatus 112 according to this disclosure is shown in FIGS. 5-7. Apparatus 112 has a first piece 116 that, illustratively, comprises a substantially flat plate and a second piece 118 that is configured to be placed upon first piece 116. Second piece 118 is generally plate-like but, unlike first piece 116, has a cavity 126 formed therein for receiving a sensor 120 of apparatus 112. In alternative embodiments, pieces 116, 118 may each have a cavity which receives respective portions of sensor 120. Although pieces 116, 118 may be made of any suitable material, in one embodiment, piece 116 is made of stainless steel material and piece 118 is made of TEFLON® material. In another embodiment, pieces 116, 118 are both made from stainless steel.

Illustrative sensor 120 of apparatus 112 comprises a plate-like element that is configured to fit within cavity 126 of second piece 118. Illustratively, sensor 120 has a first end 146, a second end 148, and an intermediate portion 150 therebetween. Illustrative sensor 120 comprises a load beam in which ends 146, 148 are movable toward and away from intermediate portion along directions that are substantially parallel with the shear plane defined between pieces 116, 118. In the embodiment shown in FIG. 6, a first slot 52 is formed between first end 146 and intermediate portion 150, and a second slot 54 is formed between second end 148 and intermediate portion 150. Slots 52, 54 are formed substantially parallel to each other and are positioned closely enough such that intermediate portion 150 is of relatively small dimension between slots 52, 54. Configuring sensor 120 in this manner permits sensor 120 to sense forces that are exerted from either first end 146 or second end 148, resulting in the deformation of intermediate portion 150.

Illustratively, intermediate portion 150 has a set of strain gages mounted thereon. The strain gages may be arranged, for example, in a half-bridge of full-bridge configuration. Leads 124 electrically couple the strain gages of sensor 120 to processing equipment, such as equipment 14 discussed above. Sensor 120 is sometimes referred to as an “S-beam” by those skilled in the art due to the ends of slots 52, 54 being open on respective opposite side edges of the deformable element. In the illustrative embodiment, the deformable “S-beam” to which the strain gages mount is made from stainless steel. Other suitable material may be used, however, if desired so long as the materials used exhibit the desired deformation characteristics.

In the embodiment shown in FIGS. 5-7, sensor 120 is mounted to first piece 116 via a set of first stops 134, which illustratively are fasteners. Each fastener 134 is a screw that comprises a threaded post which extends through washer 56 (functioning as a spacer), each fastener 134 threading into a threaded hole 58. Sensor 120 extends from fasteners 134 in a cantilevered manner. Second end 148 of sensor 120 is positioned to be engaged by an inner surface 60 of a rim 62, which is provided in second piece 118 outboard of cavity 126. Rim 62 defines cavity 126 therein. Additionally, a slot 64 is formed in rim 62 for the passage of leads 124 therethrough. When piece 118 moves in direction 38, or piece 116 moves in direction 40, or both, as shown in FIG. 7, sensor 120 deflects due to squeezing action between fasteners 134 and the portion of rim 62 that engages end 148 of sensor 120. The portion of rim 62 that engages end 148 of sensor 120, therefore, provides apparatus 112 with a second stop.

Another shear sensor apparatus 212 according to this disclosure is shown in FIGS. 8 and 9. Apparatus 212 has a first piece 216 and a second piece 218, each of which is a substantially flat, plate-like element. A first pair of stops 234 extend from piece 216 and a second pair of second stops 66 extend from second piece 218. Stops 66, 234 are cylindrical posts in the illustrative embodiment. Unlike pieces 16, 18 of apparatus 12 and pieces 116, 118 of apparatus 112, neither of the first and second pieces 216, 218 of apparatus 212 have any sensor-receiving cavity provided therein.

Apparatus 212 has a sensor 220 which illustratively has a first set of holes 258 and a second set of holes 68 formed therein. Holes 258 are configured to receive stops 234 and holes 68 are configured to receive stops 66. Sensor 220 has substantially the same shape as sensor 120 of apparatus 112. Thus, sensor 220 is configured as an S-beam that has a first end 246, a second end 248, and an intermediate portion 250 therebetween. However, although two posts and two holes are shown at each end 246, 248 of sensor 220, it should be understood that any number of posts or holes, and any configuration for stops 66, 234 is within the scope of the disclosure. Illustratively, intermediate portion 250 has a set of strain gages mounted thereon, and leads 224 that connect the strain gages to processing equipment.

In the illustrative embodiment, a quantity of adhesive is provided between stops 234 and the surfaces of sensor 220 that define holes 258 such that first end 246 of sensor 220 is fixed to plate 216. Stops 66 are loose fit into holes 68 which allows plate 218 to be easily decoupled from the remainder of apparatus 212. In apparatus 212, no portion of piece 218 engages any portion of piece 216 in sliding contact. Rather, the only sliding that occurs, if any, occurs between portions of the bottom surface of sensor 220 and the top surface of piece 216 and between portions of the top surface of sensor 220 and the bottom surface of piece 218. In the illustrative example, pieces 216, 218 and stops 66, 234 are made of stainless steel material. Other suitable materials may be used, however, if desired.

During use in the illustrative example, each apparatus 12, 112, 212 responds to shear forces between a patient and a patient support device by the initial deformation of sensor 20. Such deformation causes a peak value or “static shear” value that is representative of the shear force exerted on the shear sensor apparatus prior to movement either of the patient relative to shear sensor apparatus or prior to movement of the shear sensor apparatus relative to the patient support device. Once the first piece of each apparatus 12, 112, 212 slips relative to device 10, or once the second piece of each apparatus 12, 112, 212 slips relative to the patient, deformation of the associated sensor decreases and the measured shear value drops. In this dynamic slip situation, the shear sensor still may indicate that shear is occurring, assuming that the sensor has not completely returned to its undeformed state, but the output signal from the sensor may not correlate to the actual shear force acting upon the patient and/or device.

In the above discussion, alternatives that are mentioned in connection with any of apparatus 12, 112, 212 are intended to be applicable to all of apparatus 12, 112, 212. In addition, each apparatus 12, 112, 212 maybe used to sense shear between any two bodies that move along a shear plane, regardless of whether any portion of the two bodies are in contact. The “S-beams” disclosed herein are available from HITEC Corporation of Westford, Mass.

While the disclosure is susceptible to various modifications and alternative forms, specific exemplary embodiments thereof have been shown by way of example in the drawings and have herein been described in detail. It should be understood, however, that there is no intent to limit the disclosure to the particular forms disclosed, but on the contrary, the intention is to cover all modifications, equivalents, and alternatives falling within the spirit and scope of the disclosure as defined by the appended claims.

There is a plurality of advantages of the present invention arising from the various features of the shear-sensing apparatus described herein. It will be noted that alternative embodiments of the shear-sensing apparatus of the present invention may not include all of the features described yet still benefit from at least some of the advantages of such features. Those of ordinary skill in the art may readily devise their own implementations of a shear-sensing apparatus that incorporate one or more of the features of the present invention and fall within the spirit and scope of the present invention as defined by the appended claims.

1. An apparatus for sensing shear, the apparatus comprising
a first piece,
a second piece movable relative to-the first piece along a shear plane, and
a sensor interposed between the first piece and the second piece, a first portion of the sensor being stationary relative to the first piece, a second portion of the sensor being stationary relative to the second piece, and a third portion of the sensor being deformed as the second piece moves relative to the first piece along the shear plane, the sensor having an output signal indicative of the amount of deformation of the third portion.

2. The apparatus of claim 1, wherein the first portion of the sensor is in contact with the first piece and the second portion of the sensor is in contact with the second piece.

3. The apparatus of claim 1, wherein the sensor comprises a strain gage coupled to the third portion.

4. The apparatus of claim 1, wherein the first piece includes a stop, the first portion comprises a first surface that engages the stop, and the second portion comprises a second surface that is coupled to the second body.

5. The apparatus of claim 4, wherein the second surface is perpendicular to the first surface.

6. The apparatus of claim 4, wherein the third portion of the sensor has a third surface and the sensor comprises a strain gage that is coupled to the third surface.

7. The apparatus of claim 1, wherein the first, second, and third portions of the sensor are formed integrally from a mass of resilient material.

8. The apparatus of claim 7, wherein the resilient material comprises an elastomeric material.

9. The apparatus of claim 7, wherein the resilient material comprises a metal material.

10. The apparatus of claim 1, wherein the sensor comprises a load beam, the first portion comprises a first end region of the load beam, the second portion comprises a second end region of the load beam, and the third portion comprises an intermediate region of the load beam that interconnects the first and second end regions.

11. The apparatus of claim 10, wherein the load beam has a first slot between the first end region and the intermediate region and the load beam has a second slot between the second end region and the intermediate region.

12. The apparatus of claim 1, wherein the first piece comprises a first plate, the second piece comprises a second plate, and the sensor comprises a flat element that is situated between the first and second plates.

13. An apparatus for sensing shear, the apparatus comprising
a first piece comprising a first plate and a first stop coupled to the first plate,
a second piece comprising a second plate and a second stop coupled to the second plate, the second plate being arranged in parallel relation with the first plate, the second piece being movable relative to the first piece along a shear plane that is parallel with the first and second plates, and
a sensor comprising a body and a strain gage coupled to the body, a portion of the body being situated between the first and second stops, the portion of the body being deformable as a result of the second piece moving relative to the first piece along the shear plane, a resistance of the strain gage changing as a result of the portion of the body being deformed.

14. The apparatus of claim 13, wherein the body has a first hole and the first stop includes a first post that is received in the first hole.

15. The apparatus of claim 14, wherein the body has a second hole and the second stop includes a second post that is received in the second hole.

16. The apparatus of claim 14, wherein the first post is received in the first hole with a press fit.

17. The apparatus of claim 16, further comprising a spacer coupled to the first post, the spacer being situated between the body and the first plate, and the body being held out of contact with the first plate by the spacer.

18. The apparatus of claim 14, wherein the second piece comprises a rim extending from the second plate, the rim has a surface that engages the first plate, and a portion of the rim provides the second stop.

19. The apparatus of claim 18, wherein the rim surrounds the body.

20. The apparatus of claim 13, wherein the body has a first slot on one side and a second slot on an opposite side, the slots defining a load-sensing intermediate region therebetween.

21. The apparatus of claim 13, wherein the body comprises a third plate that is substantially parallel with the first and second plates.

22. The apparatus of claim 21, wherein the third plate has a first end region that engages the first stop, the third plate has a second end region that engages the second stop, and the third plate has an intermediate region that interconnects the first and second end regions.

23. The apparatus of claim 22, wherein the third plate has a first slot between the first end region and the intermediate region and the load beam has a second slot between the second end region and the intermediate region.

24. An apparatus for sensing shear, the apparatus comprising
a first plate,
a second plate,
a middle plate sandwiched between the first and second plates, the middle plate being deformable, and
a strain gage coupled to the middle plate.

25. The apparatus of claim 24, further comprising a first stop configured to mount the first plate to the middle plate.

26. The apparatus of claim 25, further comprising a second stop configured to mount the second plate to the middle plate.
